(19) United States
(12) Patent Application Publication
(10) Pub. No.: US 2015/0365353 A1
(43) Pub. Date: Dec. 17, 2015

(54) NETWORK MANAGEMENT DEVICE AND METHOD

(71) Applicant: FUJITSU LIMITED, Kawasaki-shi (JP)

(72) Inventor: Atsushi NAGASE, Kawasaki (JP)

(73) Assignee: FUJITSU LIMITED, Kawasaki-shi (JP)

(21) Appl. No.: 14/729,216

(22) Filed: Jun. 3, 2015

(30) Foreign Application Priority Data
Jun. 13, 2014 (JP) 2014-122141

(51) Int. Cl. H04L 12/933; H04L 12/931; H04L 12/721

(52) U.S. Cl. CPC H04L 49/10; H04L 45/66; H04L 49/351

(57) ABSTRACT

A network management device includes a memory and a processor for managing a fabric being a logical network switch including a plurality of network switches. The processor is configured to accept data on port profiles including settings for ports of the fabric, and designation of lower ports that are external ports to which the port profiles of the fabric are to be applied, associate the upper port with the lower ports based on distances, inside the fabric, between each of upper ports and the lower ports, the upper ports being ports other than the lower ports among external ports of the fabric, generate a port profile for the upper port by integrating the port profiles of the lower ports based on the associating of the upper port with the lower ports, and set the generated port profile for the upper port.

### CROSS-REFERENCE TO RELATED APPLICATION

This application is based upon and claims the benefit of priority of the prior Japanese Patent Application No. 2014-122141, filed on Jun. 13, 2014, the entire contents of which are incorporated herein by reference.

### FIELD

The embodiment discussed herein is related to network management techniques.

### BACKGROUND

In recent years, networks in data centers have been increasing in size and have become complex as the communication data amounts have been increasing. One of the technologies for constructing a network in a data center is an Ethernet fabric.

An Ethernet fabric (Ethernet being a trade mark) has a configuration in which a plurality of network switches, for example, are mutually coupled. The Ethernet fabric includes internal ports with which internal network switches communicate and external ports coupled outside the Ethernet fabric. The external ports include upper ports coupled to upper nodes of a network, such as core switches and routers, and lower ports coupled to lower nodes, such as servers and disk devices.

An Ethernet fabric may be regarded as one logical network switch including upper ports and lower ports. This enables a user to use the network without being aware of coupling inside the fabric.

A user is going to make settings for the fabric before using the fabric. However, in some cases, the user has to be aware of the coupling and the like inside the fabric, and therefore, it is not easy to configure fabric settings.

Examples of the related-art techniques include Japanese Laid-open Patent Publication No. 2013-70297, Japanese National Publication of International Patent Application No. 2013-526234, Japanese Laid-open Patent Publication No. 2013-110753, and Japanese National Publication of International Patent Application No. 2013-535922.

### SUMMARY

According to an aspect of the invention, a network management device includes a memory and a processor for managing a fabric being a logical network switch including a plurality of network switches. The processor is configured to accept data on port profiles including settings for ports of the fabric, and designation of lower ports that are external ports to which the port profiles of the fabric are to be applied, associate the upper port with the lower ports based on distances, inside the fabric, between each of upper ports and the lower ports, the upper ports being ports other than the lower ports among external ports of the fabric, generate a port profile for the upper port by integrating the port profiles of the lower ports based on the associating of the upper port with the lower ports, and set the generated port profile for the upper port.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates an outline of a system according to this embodiment;

FIG. 2 illustrates an example of a configuration of an Ethernet fabric;

FIG. 3 illustrates an example of a virtual fabric (VFAB);

FIG. 4 illustrates a configuration of a network management device;

FIG. 5 illustrates a main processing flow according to the embodiment;

FIG. 6 depicts an example of external port information;

FIG. 7 depicts an example of data on port profiles;

FIG. 8 illustrates a processing flow of a setting process for lower ports;

FIG. 9 depicts an example of distances between upper ports and lower ports;

FIG. 10 illustrates a processing flow of a port profile generation process for upper ports;

FIG. 11 depicts associations of upper ports with lower ports;

FIG. 12 illustrates a processing flow of the port profile generation process for upper ports;

FIG. 13 depicts an example of port profiles associated with an upper port;

FIG. 14 illustrates a processing flow of a port profile adjustment process;

FIG. 15 illustrates a processing flow of the port profile adjustment process;

FIG. 16 illustrates a processing flow of the port profile adjustment process;

FIG. 17 depicts associations (after change) of upper ports with lower ports;

FIG. 18 depicts an example of port profiles for upper ports; and

FIG. 19 is a functional block diagram of a computer.

### DESCRIPTION OF EMBODIMENT

According to one aspect of a disclosed embodiment, the user may easily configure fabric settings.

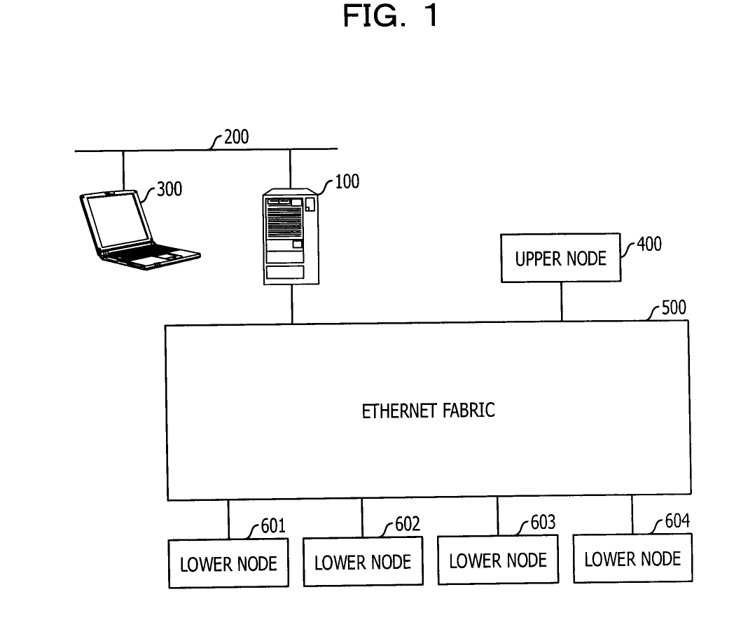

FIG. 1 illustrates an outline of a system according to this embodiment. An Ethernet fabric 500 is a logical network switch that couples an upper node 400, such as a core switch or a router, with lower nodes 601 to 604, such as servers and disk devices. Note that a network management device 100 is also coupled to the Ethernet fabric 500. The network management device 100 is coupled, for example, via a network 200 to a user terminal 300.

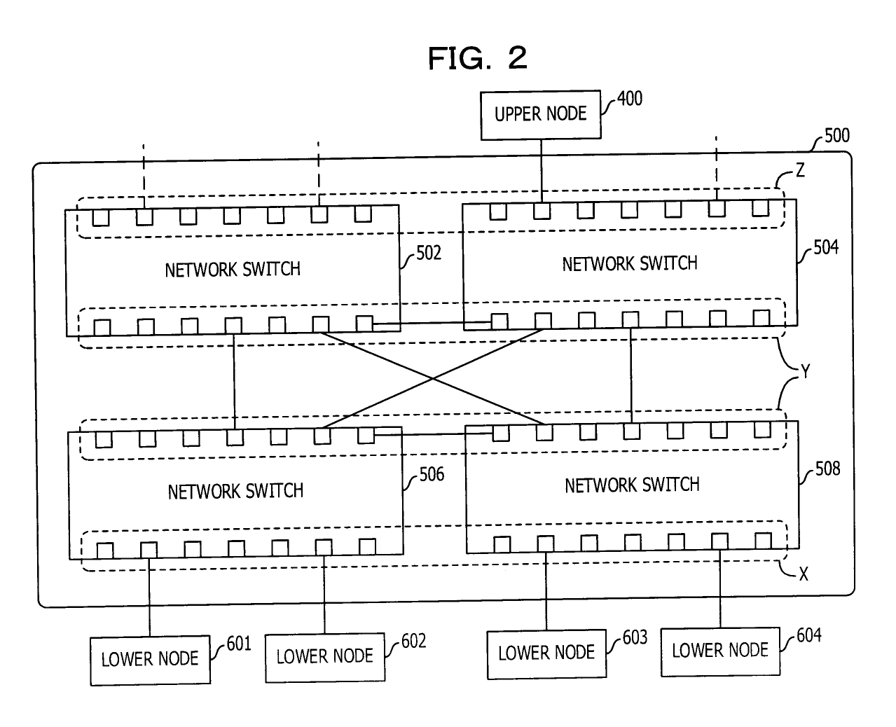

An example of a configuration of the Ethernet fabric 500 is illustrated in FIG. 2. In the example of FIG. 2, the Ethernet fabric 500 includes network switches 502 to 508, which are mutually coupled by using an internal port group Y. In such a manner, a plurality of paths are provided between network switches. For example, between the network switch 502 and the network switch 508, not only a direct link, but also a path passing through the network switch 506 and a path passing through the network switch 504 are present. Any number and any coupling form of network switches within the Ethernet fabric 500 may be employed.

As described above, the Ethernet fabric 500 includes an upper port group Z including ports coupled to the upper node 400 and a lower port group X including ports coupled to lower nodes 601 to 604.

In general, some Ethernet fabrics have functions of separating a fabric into a plurality of virtual fabrics (VFABs). A VFAB is constructed when a user arbitrarily designates upper ports and lower ports used for communication. A plurality of VFABs may be constructed on an Ethernet fabric and may be used as individual networks separate from each user.

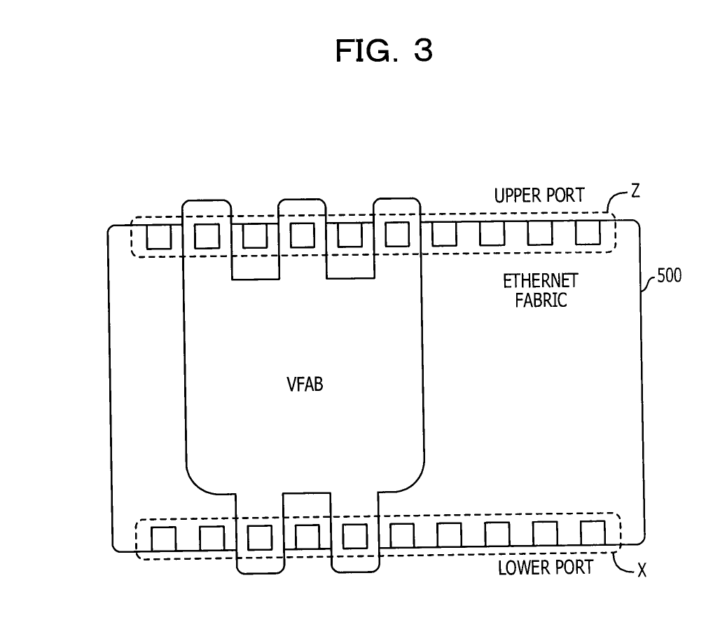

An example of a VFAB is illustrated in FIG. 3. In the example of FIG. 3, in the Ethernet fabric 500, a VFAB is constructed in such a manner as to include three upper ports in the upper port group Z and two lower ports in the lower port group X. In order to construct a network environment in which communication speed and security are ensured, various kinds of settings suitable for lower ports and upper ports included in the VFAB are made.

A profile in which various settings for a port are specified is referred to as a “port profile”. Settings such as for a virtual local area network (LAN) (VLAN), an access control list (ACL), and bandwidth for use in communication are included in the port profile. The VLAN is a setting for dividing a network, and the ACL is a setting for permitting or restricting communication with a specific address. Bandwidth is a setting related to communication speed.

Upper ports are coupled to external core switches, routers, and the like, and therefore communication from lower nodes, such as servers coupled to lower ports, is concentrated in the upper ports. For this reason, in order to configure upper ports, a user takes into consideration the settings that have been made for the coupled lower ports. That is, the user takes into consideration the size of the bandwidth to be secured and the security settings such as those for blocking and permitting communication that are to be made.

However, since an Ethernet fabric is constructed of a plurality of network switches, the size and the complexity are increased. Accordingly, it is often technically difficult to be aware of physical coupling between upper ports and lower ports and to make suitable settings. In addition, since the Ethernet fabric appears as a single logical network switch, internal communication of the Ethernet fabric is obscured. Despite the obscurity, the user makes settings while being aware of internal coupling relationships.

As described above, it is difficult to sufficiently understand coupling relationships inside the Ethernet fabric, and the like. Making suitable settings for upper ports is more difficult than making suitable settings for lower ports. These difficulties are likely to result in unsuitable settings being made. This, in turn, causes a case in which network resources are not effectively used, and, as a result, there is a surplus of bandwidth, and a situation in which, for example, communication is unintendedly cut off.

In this embodiment, in order for the user to make settings for external ports without being aware of coupling relationships inside the Ethernet fabric 500, and the like, the network management device 100 described below is provided.

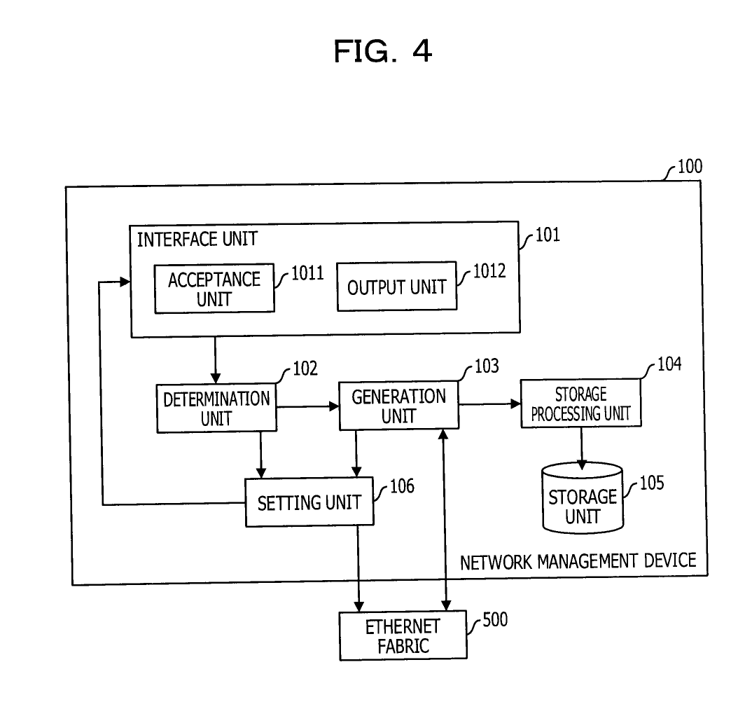

As illustrated in FIG. 4, the network management device 100 includes an interface unit 101, a determination unit 102, a generation unit 103, a storage processing unit 104, a storage unit 105, and a setting unit 106.

The interface unit 101 includes an acceptance unit 1011 and an output unit 1012. The acceptance unit 1011 receives data from the user terminal 300, and the output unit 1012 outputs a processing result of the network management device 100 to the user terminal 300.

The determination unit 102 identifies upper ports and lower ports from the data received by the acceptance unit 1011 of the interface unit 101. Then, the determination unit 102 outputs data about lower ports to the setting unit 106 and outputs data used in generating port profiles for upper ports to the generation unit 103.

The generation unit 103 acquires data on distances between upper ports and lower ports from the Ethernet fabric 500, generates port profiles for upper ports using the data received from the determination unit 102, and outputs the port profiles to the setting unit 106. The generation unit 103 outputs the generated port profiles to the storage processing unit 104.

The storage processing unit 104 stores the port profiles received from the generation unit 103 in the storage unit 105.

The setting unit 106 sets (also referred to as “assigns”) the port profiles received from the determination unit 102 and the generation unit 103 for ports designated in the Ethernet fabric 500. Note that the setting unit 106 outputs a processing result to the interface unit 101. The output unit 1012 of the interface unit 101 outputs a processing result to the user terminal 300 serving as the source of the request.

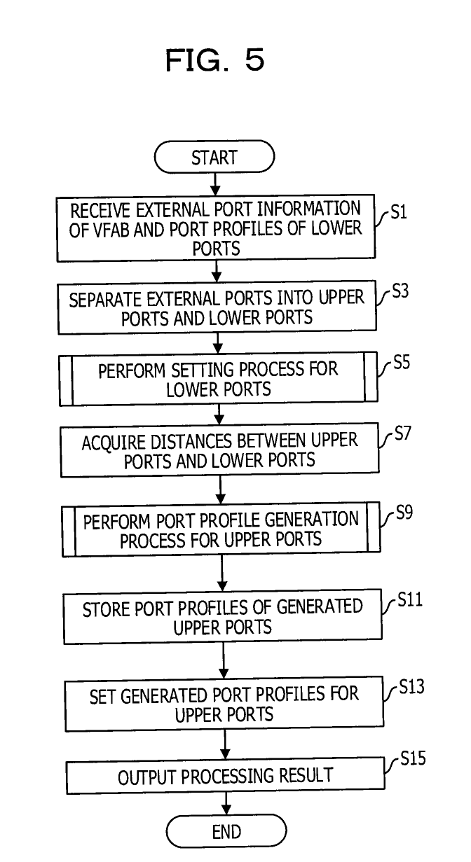

Next, with reference to FIG. 5 to FIG. 18, processing details of the network management device 100 will be described.

First, the acceptance unit 1011 of the interface unit 101 in the network management device 100 receives external port information of the VFAB and port profiles of lower ports from the user terminal 300 (FIG. 5: S1). Then, the acceptance unit 1011 of the interface unit 101 outputs the received data to the determination unit 102.

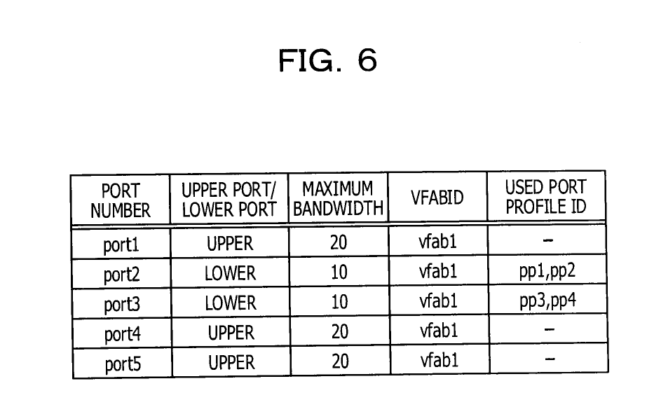

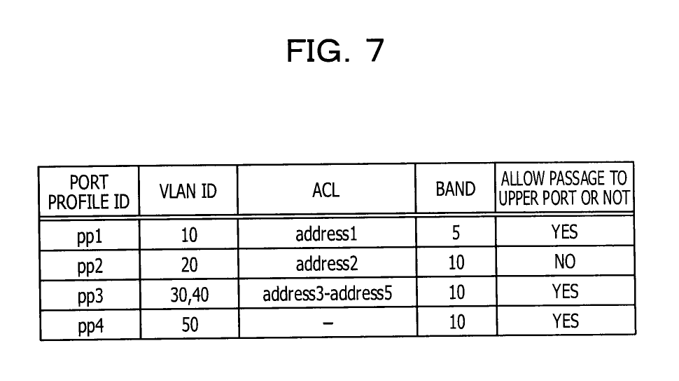

For example, the acceptance unit 1011 receives data as depicted in FIG. 6 and FIG. 7.

FIG. 6 depicts an example of external port information. The example of FIG. 6 includes a port number, which is the identifier of a port, a distinction between an upper port and a lower port, a maximum bandwidth of the external port concerned, an identifier of a VFAB in which the external port concerned is included, and the identifier of an applied port profile. In this embodiment, the identifiers (IDs) of applied port profiles are specified only for lower ports.

An example of port profiles of lower ports is depicted in FIG. 7. The example of FIG. 7 includes the identifier (ID) of a port profile, a VLAN ID, an ACL (here as a list of addresses at which passage of communication is blocked), a bandwidth used, and a flag indicating whether or not to allow passage of communication to an upper port.

The determination unit 102, upon receiving data as depicted in FIG. 6 and FIG. 7, separates external ports of the VFAB into upper ports and lower ports in accordance with external port information, outputs data on lower ports to the setting unit 106, and outputs data used in generating port profiles for upper ports to the generating unit 103 (S3).

In the example of FIG. 6, since port2 and port3 are lower ports, port profiles pp1 and pp2 are output in association with port2, and port profiles pp3 and pp4 are output in association with port3, to the setting unit 106.

In this embodiment, the data in FIG. 6 and FIG. 7 is used as is in the generation unit 103, and therefore the data in FIG. 6 and FIG. 7 is output in association with upper ports port1, port4, and port5.

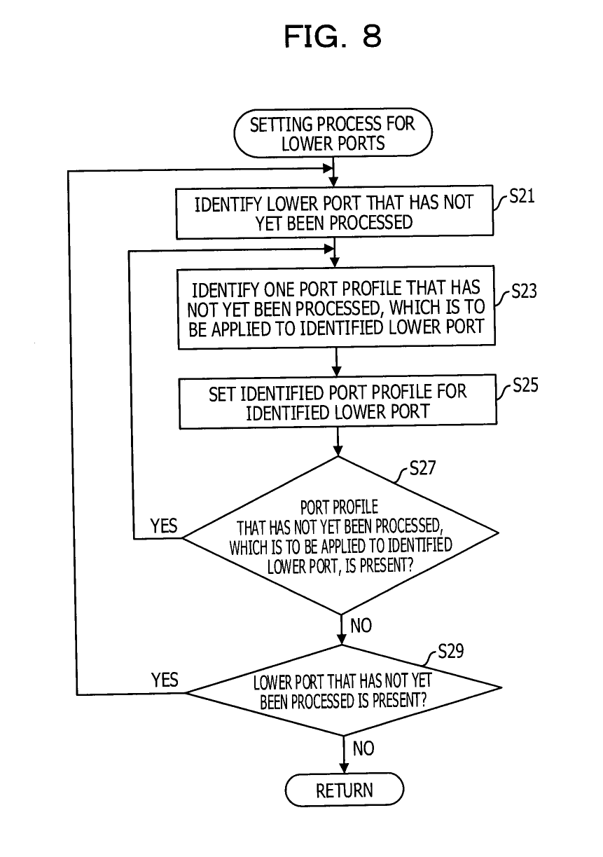

Upon output, the setting unit 106 performs a setting process for lower ports (S5). This process will be described with reference to FIG. 8.

First, the setting unit 106 identifies a lower port that has not yet been processed (FIG. 8: S21). For example, lower ports designated by the determination unit 102 are sequentially selected.

The setting unit 106 then identifies a port profile that is to be applied to the identified lower port and that has not yet been processed (S23). In the example described above, the port profiles pp1 and pp2 associated with the lower port port2 are sequentially selected.

The setting unit 106 also sets the identified port profile for the identified lower port (S25).

The setting unit 106 then determines whether or not a port profile that is to be applied to the identified lower port and that has not yet been processed is present (S27). When a port profile that has not yet been processed is present, the process returns to S23.

On the other hand, when a port profile that has not yet been processed is not present, the setting unit 106 determines whether or not a lower port that has not yet been processed is present (S29). When a lower port that has not yet been processed is present, the process returns to S21.

On the other hand, when a lower port that has not yet been processed is not present, the process returns to the processing of the calling process.

In such a way, settings for lower ports are suitably made.

Returning to the description of the process in FIG. 5, the generation unit 103 acquires distances between upper ports and lower ports from the Ethernet fabric 500 (S7).

Some implementations of the Ethernet fabric 500 have a function in which, when an upper port and a lower port are specified and an inquiry is made, the distance between the upper port and the lower port will be returned. In such a case, the function is used. Some implementations of the Ethernet fabric 500 have a function that outputs internal topology data. In the case of this function, the distance between an upper port and a lower port is computed from the inner topology data. Note that, in some cases, the distance between an upper port and a lower port is computed as, for example, a minimum number of internal links that are present between a network switch including the upper port and a network switch including the lower port. In the case of the Ethernet fabric 500 as illustrated in FIG. 2, all the network switches are mutually coupled, and therefore the minimum number of internal links is one for any combination of upper links and lower links. However, when a plurality of network switches included in the Ethernet fabric 500 are coupled in a tree-like configuration, an upper port and a lower port are coupled in some cases by a route passing through a plurality of internal links.

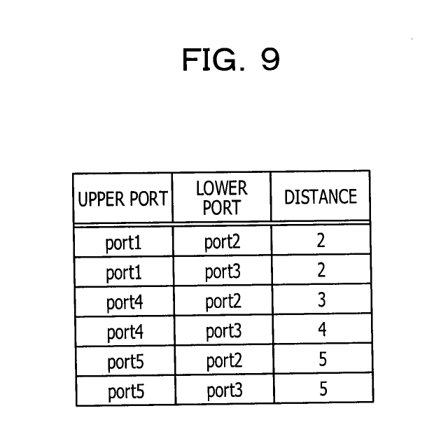

For example, it is assumed that data as depicted in FIG. 9 is acquired. In the example of FIG. 9, an acquired distance is depicted for each combination of an upper port and a lower port.

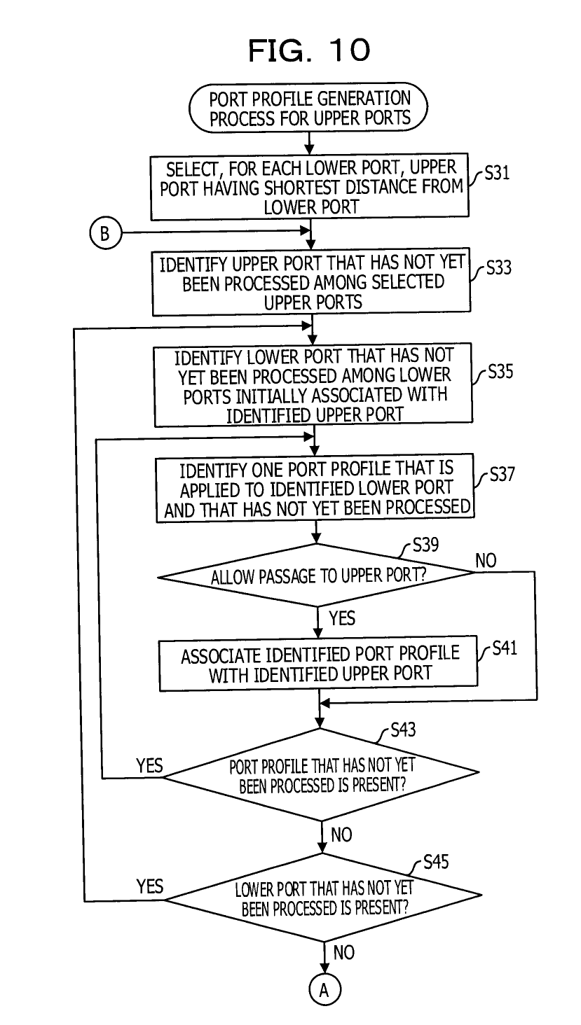

The generation unit 103 performs a port profile generation process for upper ports (S9). This processing will be described with reference to FIG. 10 to FIG. 18.

The generation unit 103 selects, for each lower port, an upper port having the shortest distance from the lower port (FIG. 10: S31).

In the example of FIG. 9, with respect to the lower port port2, the upper port port1 has the shortest distance and, with respect to a lower port port3, the upper port port1 has the shortest distance.

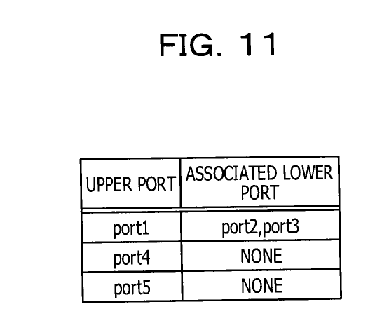

Consequently, in this stage, as illustrated in FIG. 11, the lower ports port2 and port3 are associated with the upper port port1. In this stage, no lower port is associated with other upper ports.

Next, the generation unit 103 identifies an upper port that has not yet been processed among the selected upper ports (S33). In the example described above, since only one upper port is selected, the upper port port1 is identified.

The generation unit 103 then identifies a lower port that has not yet been processed among the lower ports initially associated with the identified upper port (S35).

The generation unit 103 further identifies a port profile that is applied to the identified lower port and that has not yet been processed (S37).

The generation unit 103 then determines whether or not a setting is made to allow passage to an upper port in the identified port profile (S39). When the setting is not made to allow passage to an upper port, the process proceeds to S43. This is because when the setting is made not to allow passage to an upper port in a port profile, the port profile is inhibited from being reflected to the upper port.

On the other hand, when a setting is made to allow passage to an upper port, the generation unit 103 associates the port profile identified in S37 with the upper port identified in S33 (S41).

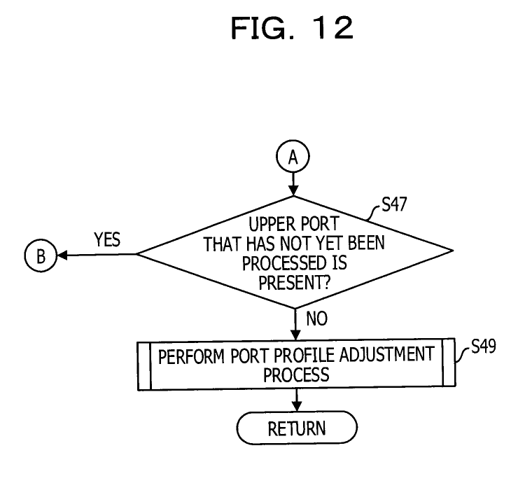

The generation unit 103 then determines whether or not a port profile that has not yet been processed is present for the identified lower port (S43). When a port profile that has not yet been processed is present, the process returns to S37. On the other hand, when a port profile that has not yet been processed is not present, the generation unit 103 determines whether or not a lower port that has not yet been processed is present (S45). When a lower port that has not yet been processed is present, the process returns to S35. On the other hand, when a lower port that has not yet been processed is not present, the process proceeds via a terminal A to the processing illustrated in FIG. 12.

With regard to the description of processing illustrated in FIG. 12, the generation unit 103 determines whether or not, among the upper ports selected in S31, an upper port that has not yet been processed is present (S47). When an upper port that has not yet been processed is present, the process returns via a terminal B to S33.

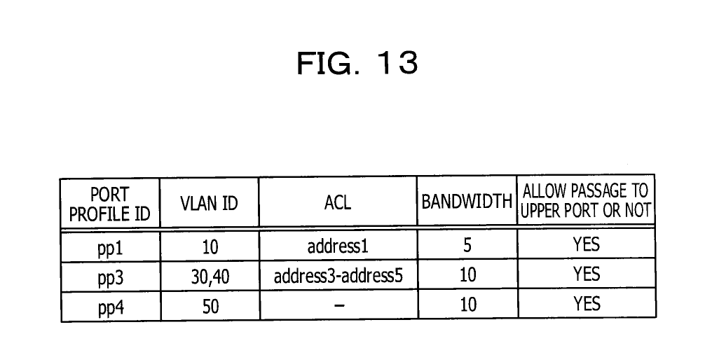

Once the process up to this point has been performed, in the example described above, data on port profiles as depicted in FIG. 13 is associated with the upper port port1. That is, a port profile pp2 for which a setting is made not to allow passage to an upper port is excluded.

On the other hand, when an upper port that has not yet been processed is not present, the generation unit 103 performs a port profile adjustment process (S49). Then, the process returns to processing of the calling process.

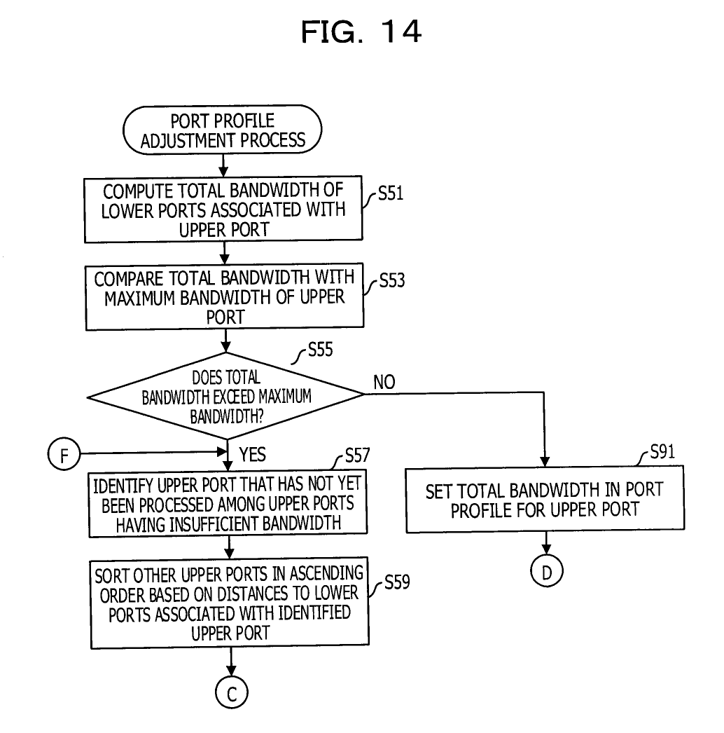

Note that the port profile adjustment process will be described with reference to FIG. 14 to FIG. 18.

First, the generation unit 103 computes, for each upper port selected in S31, a total amount of allocated bandwidth (total bandwidth) of port profiles associated with the upper port (FIG. 14: S51). In the example described above, since port profiles pp1, pp3, and pp4 are associated with the upper port port1, the total bandwidth is 25 Gbps, as depicted in FIG. 13.

The generation unit 103 then compares, for each upper port, the total bandwidth with the maximum bandwidth of the upper port (S53). In the example of FIG. 6, since the maximum bandwidth of the upper port port1 is 20 Gbps, the total bandwidth is larger than the maximum bandwidth.

When the total bandwidth exceeds the maximum bandwidth (S55: Yes route), processing of changing the association of the upper port with the lower port (including processing of S57 to S83) is performed. An upper port having a maximum bandwidth less than the total bandwidth is referred to as an upper port having insufficient bandwidth.

On the other hand, when the total bandwidth does not exceed the maximum bandwidth of the upper port (S55: No route), that is, an upper port having insufficient bandwidth is not present, processing of generating a port profile without changing the association (S91 to S95) is performed.

First, processing performed when an upper port having insufficient bandwidth is present will be described.

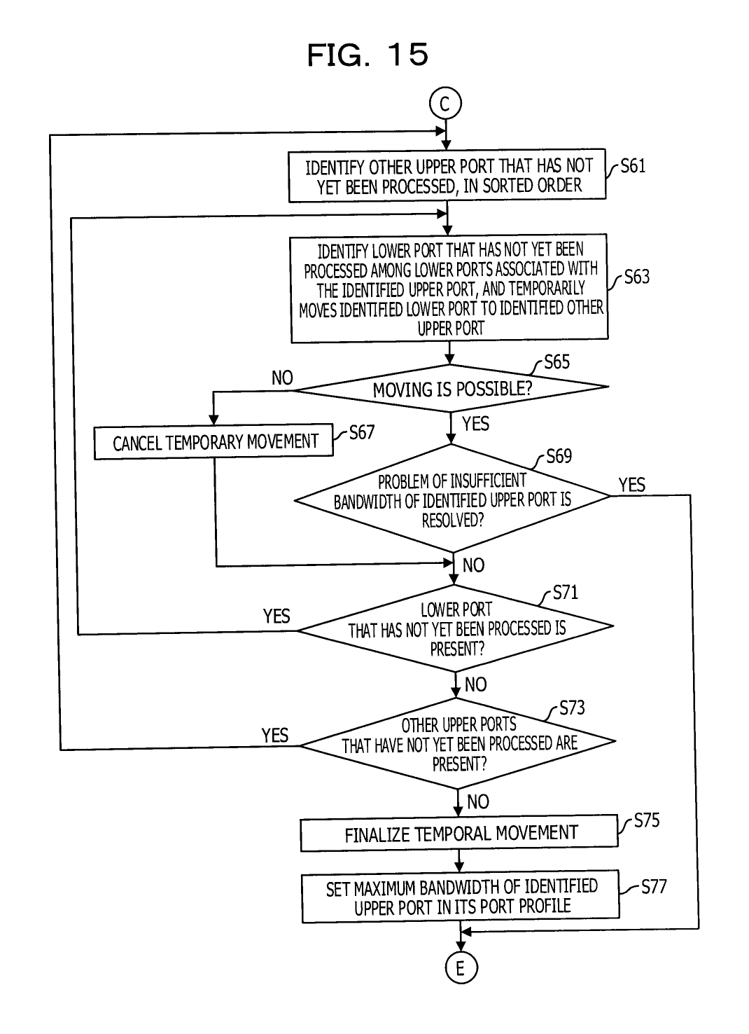

The generation unit 103 identifies an upper port that has not yet been processed among upper ports having insufficient bandwidth (S57). The generation unit 103 also sorts the other upper ports in ascending order based on distances to the lower ports associated with the identified upper port (S59). When an upper port having insufficient bandwidth is present among the other upper ports, the upper port is excluded from upper ports to be sorted. Then, the process proceeds via a terminal C to the processing illustrated in FIG. 15.

In the example described above, when processing is performed for the upper port port1, the other upper ports port4 and port5 are sorted according to distance as depicted in FIG. 9. For example, once the upper ports port4 and port5 are sorted in ascending order by using a value obtained by adding the distance of port3 and the distance of port4, the order of port4 and port5 is obtained. However, sorting may be performed based on values of other evaluation functions.

With regard to the description of processing in FIG. 15, the generation unit 103 identifies one of other upper ports that have not yet been processed, in the sorted order (S61). The generation unit 103 identifies a lower port that has not yet been processed among lower ports associated with the identified upper port, and temporarily moves the identified lower port to be associated with the identified other upper port (S63). For example, lower ports are selected in increasing order of bandwidth. During repeat processing, a lower port is identified among lower ports that are not temporarily moved.

At this point, the generation unit 103 determines in terms of bandwidth whether or not moving is possible (S65). That is, the allocated bandwidth of a port profile applied to the identified lower port is added to a total amount of allocated bandwidth (total bandwidth) of port profiles applied to lower ports associated with the identified other upper port. Then, when the result of addition exceeds the maximum bandwidth of the other upper port concerned, it is determined that moving the identified lower port to the other upper port concerned is not possible.

When moving is not possible, the generation unit 103 cancels temporary movement in S63 and maintains the association (S67). Then, the process proceeds to S71.

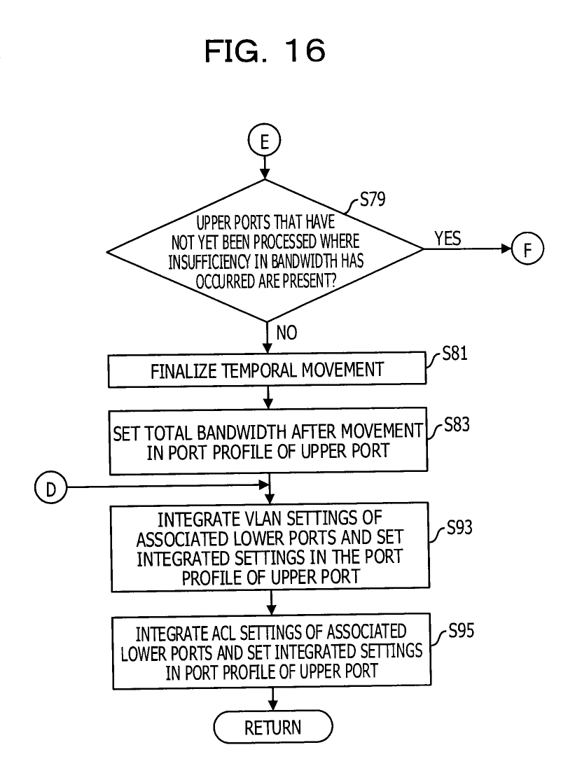

On the other hand, when moving is possible, the generation unit 103 determines whether or not the problem of insufficient bandwidth of the upper port identified in S57 is resolved (S69). That is, it is determined whether or not the value obtained by subtracting the bandwidth of a port profile applied to the moved lower port from the total bandwidth mentioned above is less than or equal to the maximum bandwidth of the identified upper port. When this condition is satisfied, the process proceeds via a terminal E to the processing illustrated in FIG. 16.

On the other hand, when the problem of insufficient bandwidth of the upper port identified in S57 is not resolved, the generation unit 103 determines whether or not, among lower ports associated with the identified upper port, a lower port that has not yet been processed is present (S71). When a lower port that has not yet been processed is present, the process returns to S63.

When a lower port that has not yet been processed is not present, the generation unit 103 determines whether or not, among other upper ports sorted, another upper port that has not yet been processed is present (S73). When other upper ports that have not yet been processed are present, the process returns to S61. On the other hand, when no other upper ports that have not yet been processed are present, the destination to which a lower port is to be moved is no longer present.

Accordingly, the generation unit 103 finalizes the temporal movement of the lower port for the upper port identified in S57 (S75). Then, the generation unit 103 sets the maximum bandwidth of the upper port identified in S57 in the port profile of that upper port (S77). Then, the process proceeds via a terminal E to the processing illustrated in FIG. 16.

With regard to the description of processing in FIG. 16, the generation unit 103 determines whether or not upper ports that have not yet been processed and where insufficient bandwidth was available are present (S79). When upper ports that have not yet been processed and where insufficient bandwidth was available are present, the process returns via a terminal F to S57.

In such a way, for each upper port where insufficient bandwidth was available, lower ports associated with the upper port are moved to other upper ports, so that the problem of insufficient bandwidth of upper ports is resolved.

When upper ports that have not yet been processed and where insufficient bandwidth was available are not present, the generation unit 103 finalizes existing temporal movement of lower ports (S81). In addition, the generation unit 103 sets, for each upper port other than the upper port processed in S77, the total bandwidth after movement of lower ports in the port profile of the upper port concerned (S83).

In the example described above, among the lower port port2 and the lower port port3 associated with the upper port port1, the lower port port2 with lower allocated bandwidth is selected and moved to the upper port port4 selected first in the order sorted in S59. As a result, the bandwidth “5” of the port profile pp1 applied to the lower port port2 is lower than a maximum bandwidth “20” of the upper port port4, and it is determined that movement is possible.

By subtracting bandwidth “5” of the port profile pp1 applied to the moved lower port port2 from the total bandwidth “25” before the movement, the total bandwidth “20” after the movement is obtained. This is less than or equal to the maximum bandwidth “20” of the upper port port1. Consequently, temporal movement is finalized.

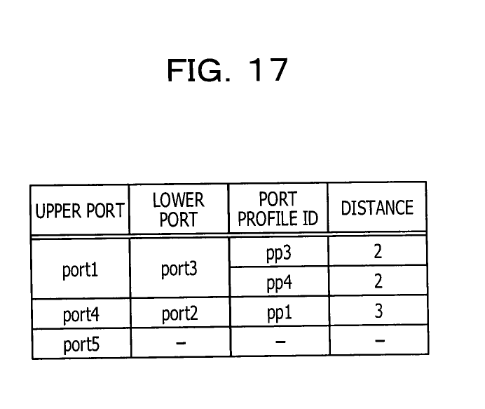

That is, the associations of upper ports with lower ports enter a state as depicted in FIG. 17. For the port profile pp2, since a setting is made not to allow passage to an upper port, no associations are made.

Returning now to the description of the process in FIG. 14, when no upper port having insufficient bandwidth is present, the generation unit 103 sets, for each upper port with which lower ports are associated, the total bandwidth in a port profile for the upper port concerned (S91). Then, the process proceeds via a terminal D to the processing illustrated in FIG. 16

Subsequently, the generation unit 103 integrates, for each upper port with which lower ports are associated, VLAN settings of the associated lower ports and sets the integrated settings in the port profile of the upper port concerned (S93).

The generation unit 103 integrates, for each upper port with which lower ports are associated, ACL settings of the associated lower ports and sets the integrated settings in the port profile of the upper port concerned (S95).

The generation unit 103 outputs the port profiles generated in such a way to the storage processing unit 104 and the setting unit 106.

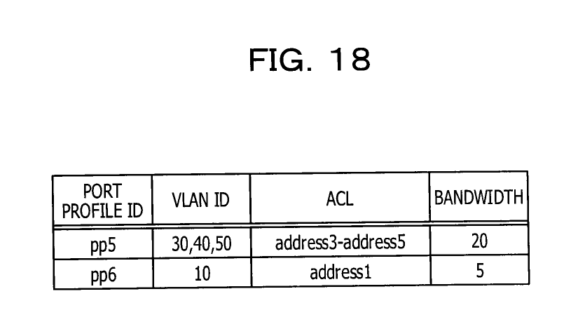

In the examples described above, for the upper port port1, the port profiles pp3 and pp4 are integrated. For example, the VLAN IDs of these port profiles are 30, 40, and 50, and therefore “30, 40, 50” is set. The ACLs of these port profiles are no setting and “address3-address5”, and therefore “address3-address5” is set. For the upper port port4, the port profile pp1 is used. As a result, as depicted in FIG. 18, a port profile pp5 for the upper port port1 and a port profile pp6 for the upper port port4 are generated. Integrating settings in the second row and the third row of FIG. 13 produces the port profile pp5 in FIG. 18. The settings in the first row of FIG. 13 match the port profile pp6 in FIG. 18.

By performing processing as described above, the associations of upper ports with lower ports are generated based on distances between the upper ports and the lower ports. Therefore, even without knowledge of the inside of the Ethernet fabric 500, the user is able to suitably generate port profiles of upper ports. Note that the associations are adjusted based on the maximum bandwidth of upper ports and, as a result, problems of, for example, a congestion occurring later become less likely to arise.

Returning to the description of the process in FIG. 5, the storage processing unit 104 stores port profiles for upper ports received from the generation unit 103 in the storage unit 105 (S11).

In addition, the setting unit 106 sets the port profiles for upper ports received from the generation unit 103 for the upper ports concerned (S13).

The setting unit 106 then outputs processing completion to the output unit 1012 of the interface unit 101, and the output unit 1012 outputs a processing result to the user terminal 300 serving as the source of the request (S15). Note that when an upper port has insufficient bandwidth, or when settings for ports are unsuccessfully made, the user of the user terminal 300 may be notified by using a processing result.

Performing processing as described above facilitates making settings of external ports of the Ethernet fabric. Furthermore, bandwidth of the upper ports is suitably set, and thus the user does not have to consider securing the communication band for setting upper ports. Furthermore, the user merely has to make settings for lower ports without having to be aware of the coupling state inside the Ethernet fabric 500. Furthermore, settings of security such as VLANs and ACLs are automatically made for upper ports. This facilitates making settings for security.

Thus, network resources are utilized effectively, and the chance of communication failing due to a human setting error or setting omission is reduced.

Although the embodiment of this disclosure has been described above, it is to be understood that the disclosure is not limited to this. For example, processing for adjusting associations between upper ports and lower ports may be changed based on various policies. That is, while an example in which lower ports are selected in increasing order of bandwidth has been described, the order in which lower ports are selected may be reversed. In addition, for the order in which upper ports having insufficient bandwidth are selected, upper ports may be selected based on, for example, the priority order of upper ports.

Furthermore, the configuration of the network management device 100 illustrated in FIG. 4 is exemplary and, in some cases, is different from the program module configuration. Furthermore, for the processing flow, the processing order may be changed or a plurality of pieces of processing may be performed in parallel as long as the processing result is not changed.

The network management device 100 may be configured such that the functions are shared by a plurality of computers.

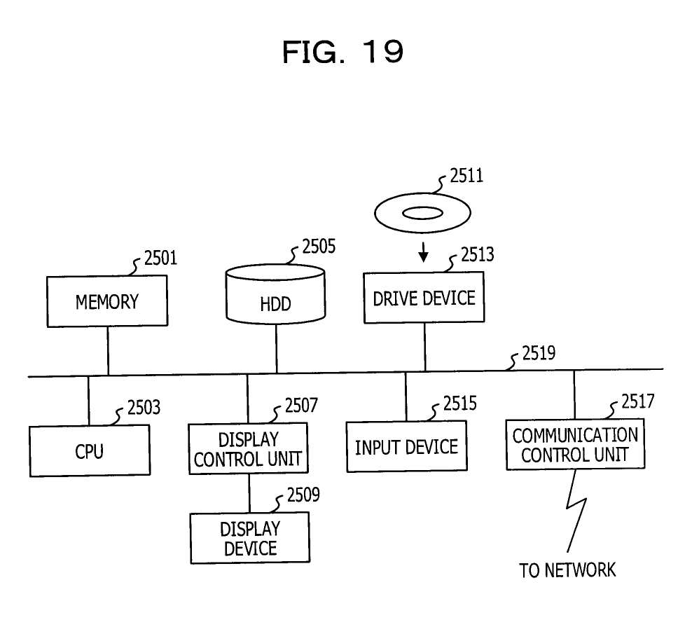

Note that the network management device 100 described above is a computer device in which, as illustrated in FIG. 19, a memory 2501, a central processing unit (CPU) 2503, a hard disk drive (HDD) 2505, a display control unit 2507 coupled to a display device 2509, a drive device 2513 for a removable disk 2511, an input device 2515, and a communication control unit 2517 for coupling to a network are coupled via a bus 2519. An operating system (OS) and application programs for performing processing in this embodiment are stored on the HDD 2505 and, when executed by the CPU 2503, are read from the HDD 2505 to the memory 2501. The CPU 2503 controls the display control unit 2507, the communication control unit 2517, and the drive device 2513 in accordance with the processing details of application programs so as to cause them to perform predetermined operations. Data being processed is stored mainly in the memory 2501 but may be stored on the HDD 2505. In the embodiment of the techniques of this disclosure, application programs for performing processing described above are stored and distributed on the computer-readable removable disk 2511, and are installed from the drive device 2513 onto the HDD 2505. The application programs are sometimes installed via a network, such as the Internet, and the communication control unit 2517 onto the HDD 2505. Such a computer device implements various kinds of functions as described above when hardware, such as the CPU 2503 and the memory 2501, and programs, such as the OS and application programs, closely cooperate.

The embodiment described above is summarized as follows.

A network management device according to this embodiment includes (A) an acceptance unit that, for a fabric being a logical network switch constructed of a plurality of network switches, accepts data on port profiles and designation of lower ports that are external ports to which the port profiles are to be applied, (B) a generation unit that, based on distances inside the fabric between each of the upper ports that are used as external ports of the fabric and that are ports other than the lower ports, and the lower ports, associates the upper port with the lower ports, and, based on the associating of the upper port with the lower ports, generates a port profile for the upper port by integrating the port profiles of the lower ports, and (C) a setting unit that sets the generated port profile for the upper port.

If there is data on lower ports, a port profile for an upper port is automatically generated. For this reason, the user may easily make settings of the fabric without considering coupling relationships inside the fabric.

Note that the port profiles described above may include data on allocated bandwidth. In this case, the generation unit mentioned above may (b1) determine whether or not a total amount of allocated bandwidth included in port profiles to be applied to the lower ports associated with the upper port exceeds a bandwidth of the upper port, and (b2) for a first upper port for which the total amount exceeds the bandwidth of the upper port, perform a change process for changing the associating.

In such a way, associations of upper ports with lower ports are made so as to inhibit upper ports, where communication is concentrated, from having insufficient bandwidth as much as possible.

Furthermore, the port profiles described above may include designation of whether or not to allow passage of communication with an upper port. In this case, the generation unit mentioned above may (b3) exclude, from objects of integration, the port profiles in which it is designated that communication is not allowed to pass to the upper port among the port profiles of the lower ports. This is because consideration of such port profiles is unnecessary for port profiles for upper ports.

Furthermore, the change process mentioned above may (b21) be a process in which an association of a lower port associated with the first upper port is changed to a third upper port sequentially selected based on a distance to a lower port associated with the first upper port, among second upper ports other than the first upper port, so as to cause a total amount of allocated bandwidth of a lower port associated after the changing to be less than or equal to a bandwidth of the first upper port. In such a way, the problem of insufficient bandwidth may be resolved while the path between upper ports and lower ports is inhibited from detouring as much as possible.

Note that programs for causing a processor or a computer to execute processing as described above may be created. The programs are stored on a computer-readable storage medium or a storage device, such as a flexible disc, an optical disc such as a compact disc read-only memory (CD-ROM), a magneto-optical disc, a semiconductor memory (for example, a ROM), and a hard disk. Note that data being processed is temporarily stored in memory such as a RAM.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A network management device comprising:
a memory; and
a processor coupled to the memory and configured to:
for a fabric being a logical network switch including a plurality of network switches, accept data on port profiles including settings for ports of the fabric, and designation of lower ports that are external ports to which the port profiles of the fabric are to be applied,
associate the upper port with the lower ports based on distances, inside the fabric, between each of upper ports and the lower ports, the upper ports being ports other than the lower ports among external ports of the fabric,
generate a port profile for the upper port by integrating the port profiles of the lower ports based on the associating of the upper port with the lower ports, and
set the generated port profile for the upper port.

2. The network management device according to claim 1, wherein
the port profiles include data on allocated bandwidth, and
the processor is further configured to
determine whether a total amount of allocated bandwidth included in port profiles to be applied to the lower ports associated with the upper port exceeds bandwidth of the upper port, and
perform a change process for changing the associating for a first upper port for which the total amount exceeds the bandwidth of the upper port.

3. The network management device according to claim 1, wherein
each of the port profiles includes designation of whether to allow passage of communication to an upper port, and
the processor is further configured to
exclude, from objects to be integrated, the port profiles in which it is designated that passage of communication is not allowed to the upper port, among the port profiles of the lower ports.

4. The network management device according to claim 2, wherein
the change process being a process in which
an association of a lower port associated with the first upper port is changed to a third upper port sequentially selected based on a distance to the lower port associated with the first upper port, among second upper ports other than the first upper port, so as to cause a total amount of allocated bandwidth of a lower port associated after the change to be less than or equal to a bandwidth of the first upper port.

5. A network system comprising:
a plurality of network switches coupled for composing a fabric that is a logical network switch; and
a network management device for managing the plurality of network switches,
wherein
the network management device includes:
a memory; and
a processor coupled to the memory and configured to:
for a fabric being a logical network switch including a plurality of network switches, accept data on port profiles including settings for ports of the fabric, and designation of lower ports that are external ports to which the port profiles of the fabric are to be applied,
associate the upper port with the lower ports based on distances, inside the fabric, between each of upper ports and the lower ports, the upper ports being ports other than the lower ports among external ports of the fabric,
generate a port profile for the upper port by integrating the port profiles of the lower ports based on the associating of the upper port with the lower ports, and
set the generated port profile for the upper port.

6. The network system according to claim 5, wherein
the port profiles include data on allocated bandwidth, and
the processor is further configured to
determine whether a total amount of allocated bandwidth included in port profiles to be applied to the lower ports associated with the upper port exceeds bandwidth of the upper port, and
perform a change process for changing the associating for a first upper port for which the total amount exceeds the bandwidth of the upper port.

7. The network system according to claim 5, wherein
each of the port profiles includes designation of whether to allow passage of communication to an upper port, and
the processor is further configured to
exclude, from objects to be integrated, the port profiles in which it is designated that passage of communication is not allowed to the upper port, among the port profiles of the lower ports.

8. The network system according to claim 6, wherein
the change process being a process in which
an association of a lower port associated with the first upper port is changed to a third upper port sequentially selected based on a distance to the lower port associated with the first upper port, among second upper ports other than the first upper port, so as to cause a total amount of allocated bandwidth of a lower port associated after the change to be less than or equal to a bandwidth of the first upper port.

9. A network management method comprising:
for a fabric being a logical network switch including a plurality of network switches, accepting, by a processor, data on port profiles including settings for ports of the fabric, and designation of lower ports that are external ports to which the port profiles of the fabric are to be applied;
associating, by the processor, the upper port with the lower ports based on distances, inside the fabric, between each of upper ports and the lower ports, the upper ports being ports other than the lower ports among external ports of the fabric;
generating, by the processor, a port profile for the upper port by integrating the port profiles of the lower ports based on the associating of the upper port with the lower ports; and
setting, by the processor, the generated port profile for the upper port.

10. The network management method according to claim 9, wherein the method further comprising:
determining, by the processor, whether a total amount of allocated bandwidth included in port profiles to be applied to the lower ports associated with the upper port exceeds bandwidth of the upper port, and
performing, by the processor, a change process for changing the associating for a first upper port for which the total amount exceeds the bandwidth of the upper port.

11. The network management method according to claim 9, wherein
each of the port profiles includes designation of whether to allow passage of communication to an upper port, and
the method further comprising:
excluding, by the processor, from objects to be integrated, the port profiles in which it is designated that passage of communication is not allowed to the upper port, among the port profiles of the lower ports.

12. The network management method according to claim 10, wherein
the change process being a process in which
an association of a lower port associated with the first upper port is changed to a third upper port sequentially selected based on a distance to the lower port associated with the first upper port, among second upper ports other than the first upper port, so as to cause a total amount of allocated bandwidth of a lower port associated after the change to be less than or equal to a bandwidth of the first upper port.
